(19) United States
(12) Patent Application Publication
(10) Pub. No.: US 2012/0135297 A1
(43) Pub. Date: May 31, 2012

(54) Thin Battery

(75) Inventor: Xiachang Zhang, Espoo (FI)

(73) Assignee: ENFUCELL LTD, Vantaa (FI)

(21) Appl. No.: 13/376,712

(22) PCT Filed: Jun. 9, 2010
(86) PCT No.: PCT/FI2010/050476

§ 371 Date: Feb. 9, 2012

(30) Foreign Application Priority Data
Jun. 10, 2009 (FI) 20095645

(51) Int. Cl. H01M 6/12; H01M 4/50

(52) U.S. Cl. 429/162; 252/182.1

(57) ABSTRACT

A thin battery with improved properties containing a cathode paste is presented. The cathode paste comprises a cathode active material, an electrolyte solution, one or more binding agent and boric acid. A method for preparing a cathode paste and a cathode are also provided.

### CROSS-REFERENCE TO RELATED APPLICATION

This application is a National Stage application of International Application No. PCT/FI2010/050476, filed Jun. 9, 2010, which is incorporated by reference herein in its entirety.

### BACKGROUND

1. Field

The invention relates to a thin flexible battery, and in particular, to a cathode paste usable in the battery, providing improved performance properties for a thin battery. Also, a method for manufacturing the cathode paste and a cathode half-cell are provided.

2. Description of the Related Art

US 2003/0044686 A1 discloses a conformal separator for an electrochemical cell disposed at the interface of the anode and cathode, providing electrical isolation between the anode and cathode. To improve the performance of a cell, an improved separator construction is provided by including a borate derivate, like boric acid, into the separator. As the separator is made of crosslinkable polymer, a crosslinked network structure of the separator is achieved. This separator is reported to have improved characteristics, i.a. reduced wall thickness and high ionic conductivity between the anode and cathode, compared to those of non-woven fabrics.

The separator is applicable to both traditional cylindrical cells and button-size metal-air cells. All of this type of batteries have a metal shell outside and radially compressed seal side wall between the anode and cathode to prevent leakage of an electrolyte.

The present invention relates to a thin battery the construction of which is notably different from that of US 2003/0044686 A1. As is commonly recognized, thin batteries have unique properties which distinguish them from conventional batteries, and provide a wide range of applications not possible to be realized by the conventional batteries, such as powers sources for consumer products and for micro-sized applications, like powering smart cards, Radio Frequency Identification (RFID) tags, and generally in low power applications, such as in Light Emitting Diodes (LEDs).

Generally, a thin battery assembly comprises an anode material and cathode material which are applied as aqueous pastes on opposite sides of one or more separator layers. The separator layer can be made of paper, plastics or any other material in a form of thin foil. Separator is typically of paper and can comprise one or more paper layers. The battery also comprises an electrolyte.

One problem of the current flexible thin batteries composed of one or more anode layer, separator layer and cathode layer is that delamination of the various layers in the battery assembly occurs to some extent during the life time, i.e. during the storage and use, of the battery. Unlike in conventional batteries, there is no metal shell in thin batteries to press the various layers together to prevent delamination. The delamination effect causes a remarkable deterioration in the battery performance and can even stop the function entirely. In particular, the reduced performance can be seen during the long-term use and storage of the battery.

Thus, an improved thin battery is needed which maintains a good performance throughout its life time.

### SUMMARY

An object of the present invention is to provide a thin battery which avoids the disadvantages associated with the current thin batteries. The object of the invention is achieved by arrangements which are characterized by what is stated in the independent claims.

It was surprisingly found that by including boric acid in a cathode paste applied on a cathode, it is possible to avoid delamination of the various layers of the battery, especially of the cathode, printed onto each other in the manufacturing process to form a battery assembly. Delamination causes remarkable problems during the life time of the battery. Reduced delamination improves the batteries performance, and can especially be seen during the long-term storage and/or use.

It is an advantage of the present invention that a cathode paste including a suitable amount of boric acid can be more easily printed on the cathode collector compared to that including no boric acid due to its viscosity modification effect in the cathode paste composition. Furthermore, it has been recognised that the use of boric acid increases the homogeneity and uniformity of the cathode paste contributing to a good performance of a thin battery.

Also, it has been found that boric acid increases the pH of the cathode paste. The pH increase has a benefit in that open voltage of the battery increases.

Furthermore, it has been found the boric acid increases the ionic conductivity of the cathode paste. The ionic conductivity increase has another benefit in that the internal resistance value of the battery decreases which renders the battery give out higher peak current and more energy.

Another object of the invention is to provide a cathode paste for a thin battery.

A further object of the present invention is to provide a cathode comprising the cathode paste of the present invention.

Yet a further object of the invention is to provide a process for preparing a cathode paste of the invention.

### BRIEF DESCRIPTION OF THE DRAWING

FIG. 1 illustrates a schematic view of a typical thin battery assembly of the invention.

### DETAILED DESCRIPTION

Battery Structure

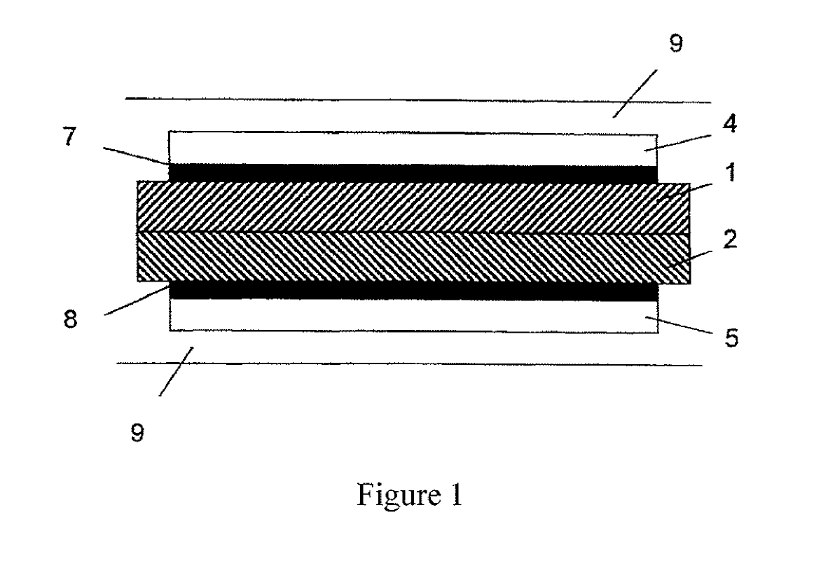

Like a conventional battery, a thin battery assembly of the invention is composed of an anode electrode, a cathode electrode and a separator disposed therebetween. An example of typical assembly of a thin battery of the invention is described in FIG. 1. The term “thin battery”, in context of the present invention, is to be understood as “layer-structured batteries” in any shape or size. It has a characteristic of a flexible and bendable structure. The thickness of a thin battery is typically less than 1 mm.

Manufacture

The manufacture of the thin battery composed of several layers of the invention can be performed in a conventional manner and can be accomplished, for example, as disclosed in WO 2008/096033. In an exemplary manufacturing process, separator papers 1, 2 are wetted with an electrolyte solution whereafter an anode material 7 is applied on a first separator paper 1, and a cathode material 8 is applied on a second separator paper 2 or on the cathode collector 5 by a printing or coating procedure. Wetting of the separator can also be performed by printing the electrolyte solution only on one of the separator papers. The separator can also comprise more than two paper layers. Additionally, the separator can be of other material than paper, for instance plastics like polymer films. The separator papers 1, 2 are then combined by pressing them together so that the anode and cathode materials are outermost, respectively. If desired, the combined separator papers are then cut into desired forms and sizes. The anode and cathode materials are then applied on an anode collector 4 and a cathode collector 5, respectively, by printing or coating. If desired, the collectors thus obtained are cut again into desired forms and sizes. Finally, a cover material 9, like polypropylene, polyethylene, metalized polyethylene terephtalate, polyester, or any other known cover material is applied on both sides of the combined anode and cathode collectors to form an envelope around the product.

Cathode

An object of the invention is to provide a cathode paste for a cathode electrode to be used in a thin battery. The cathode paste of the invention comprises a cathode active material, an electrolyte solution, one or more binding agent and boric acid. The term paste in the context of the present invention is to be understood as a viscous aqueous dispersion of solid particles included in the paste.

The cathode active material can be, e.g., ferrate, iron oxide, cuprous oxide, cobalt oxide, manganese dioxide, lead dioxide, silver oxide and nickel oxyhydroxide, nickel dioxide, silver peroxide, permanganate or bromate. In a specific embodiment of the invention, the cathode active material is manganese dioxide.

The electrolyte included in the cathode paste can be, e.g., ZnCl₂, NH₄Cl, KOH, NaOH. In a specific embodiment of the invention, the cathode paste comprises ZnCl₂ electrolyte in an amount ranging from 3 M to 10 M, preferably from 8 M to 9 M.

The content of boric acid in the cathode paste ranges from 0.02 to 0.2% on weight basis of the cathode paste. In a specific embodiment of the invention, the content ranges from 0.05% to 0.15% on weight basis of the cathode paste. In another specific embodiment of the invention, the amount is 0.08% on weight basis of the cathode paste.

The cathode paste can further comprise conductive material, such as carbon powder, like graphite powder, soot, carbon black, carbon nanotubes or combinations thereof. The amount of the conductive material in the cathode paste ranges from about 5 to 20% on weight basis of the cathode active material, the preferable amount being 10% on weight basis of the cathode active material.

The cathode paste further comprises additive(s), like binding agent, such as polyvinyl alcohol (PVA), carboxy methylcellulose (CMC), or mixture thereof. The additive is included to bind various ingredients in the paste together to form a paste. Suitable amount of the binding agent ranges from 2 to 10% on weight basis of the electrolyte solution, preferably from 3 to 5% on weight basis of the electrolyte solution.

In a specific embodiment of the invention, the cathode paste comprises MnO₂ as a cathode active material, PVA as a binding agent, graphite powder as a conductive material, ZnCl₂ as an electrolyte, and boric acid. In another specific embodiment, the cathode paste comprises MnO₂ as a cathode active material, PVA and CMC as binding agents, graphite powder and carbon nanotubes as a conductive material, ZnCl₂ as an electrolyte, and boric acid.

Anode

An anode material for the anode electrode used in a thin battery of the present invention comprises an anode active material, like metal powder, such as of Cu, Pb, Ni, Fe, Cr, Zn, Al, or Mg. In a specific embodiment of the invention, the anode active material is zinc. The anode material is applied in a form of a dry ink or a paste. To form an anode paste, an electrolyte solution is mixed with an anode active material. As an electrolyte solution, the same materials as those in the cathode paste can be used.

The anode paste can further comprise conductive material, such as carbon powder, like graphite powder, soot, carbon black, carbon nanotubes or combinations thereof. The amount of the conductive material in the anode paste ranges from about 1 to 5% on weight basis of the anode active material, the preferable amount being about 2% on weight basis of the anode active material.

The anode paste can further comprise additives, like binding agents, such as polyvinyl alcohol (PVA), carboxy methylcellulose (CMC), or a mixture thereof. Suitable amount of the binding agent ranges from 2 to 10% on weight basis of the electrolyte solution, preferably from 3 to 5% on weight basis of the electrolyte solution.

In a specific embodiment of the invention, the anode material is in a dry form composed of powdered Zn and carbon ink. The anode material is prepared by adding zinc powder to the conductive carbon ink and keeping stirring until a homogenous mixture is obtained. Examples of suitable commercial zinc powders of battery grade are e.g. Grillo-Werke Aktiengesellschaft GZN-3-0 and Xstara EC-100 having a particle size of less than 50 μm and purity of more than 99%.

Collector

A collector material for anode and cathode electrodes may be conductive carbon ink, carbon film or any other material which s chemically inert but conductive enough.

The invention further provides a thin battery with a multilayer structure comprising the cathode paste of the invention for a cathode electrode as one layer. As an anode material for providing an anode electrode for example, Zn as an anode active material in dry form, i.e. as ink, or in a paste form, can be used. The separator layer is paper, for example. The entire multilayer battery assembly is covered by a layer of polymeric film, like polyethylene, polypropylene, metalized polyethylene terephtalate, polyester, or any other polymeric films.

The invention further provides a cathode comprising the cathode paste of the invention. In addition, the cathode comprises a separator layer, like paper, a cathode collector and a cover material.

The invention further provides a method for preparing a cathode paste comprising the steps of:
mixing a cathode active material, an optional conductive material and boric acid together to form a first, powered mixture,
mixing an electrolyte solution and binding agent(s) together to form a second mixture,
adding the second mixture to the first mixture to form a cathode paste.

Alternatively, the method of the invention comprises the steps of:
mixing a cathode active material with an optional conductive material to form a first, powdered mixture,
mixing an electrolyte solution, binding agent(s) and boric acid together to form a second mixture,
adding the second mixture to the first mixture to form a cathode paste.

In a specific embodiment of the invention, the cathode paste is manufactured by dissolving boric acid into an electrolyte solution.

As stated above, the delamination of various layers of the thin battery construction of the invention can be avoided by using boric acid in the cathode paste. The reduced delamination phenomenon is presumably derivable from an improved binding between the cathode collector ink and the various chemicals present in the cathode paste, on the one hand, and between the cathode paste and the separator onto which the cathode paste is applied, on the other hand. In a specific embodiment of the cathode paste of the invention, boric acid forms a crosslinked network structure with a polyvinyl alcohol polymer through hydrogen bonding of hydroxyl groups of the polymer backbone. In another specific embodiment of the invention where paper material is used as a separator layer in the battery, reduced delamination effect may also be derived from the fact that as the cathode paste is in contact with the separator paper, an increased binding between the layers may still be enhanced due to the crosslinking reactions between the amorphous regions of cellulose structure of paper and boric acid, holding the long cellulose chains together even more tightly. Binding force between the layers is thereby increased and delamination decreased which provides an improvement in the performance of the battery.

Viscosity

An important feature of the thin battery of the invention is the viscosity of an electrolyte solution used in the cathode paste, i.e. the viscosity of the cathode paste. When applying the cathode paste on the cathode collector and further assembling it into battery, the quality of the battery depends on viscosity. It has been now found that including boric acid in a cathode paste the viscosity formation is enhanced. If the viscosity of the electrolyte solution is too high, admixture of cathode active materials into the electrolyte solution and printing process of the cathode paste onto a cathode collector becomes difficult. On the other hand, if the viscosity of an electrolyte solution is too low, difficulties may arise in printing of the desired amount of the cathode paste onto the cathode collector. Also, at a low viscosity range of an electrolyte solution the printed cathode paste owns a high mobility in the battery assembly which causes serious short circuit problems due to the penetration of the cathode paste into an anode side of the battery. Thus, control of the viscosity of the electrolyte solution or cathode paste is important to provide an optimum performance for the battery. The suitable viscosity range is controlled by the content of boric acid in the cathode paste. If the content is too high, also the viscosity rises too high making the printing of the cathode paste onto the separator or the cathode collector difficult.

In the following, the non-limiting examples are given to further illustrate the invention. All the parts and percentages given in the Examples are on weight basis.

### EXAMPLES

An effect of boric acid on the conductivity and pH of an electrolyte solution containing binder was tested with various concentrations of boric acid. Tests were performed with four different ZnCl₂ electrolyte concentrations, i.e. 5 M, 6 M, 7 M and 8 M. The electrolyte solution contained an amount given above of ZnCl₂, 1.6% of PVA, and 2.25% of CMC.

The conductivity was measured by using FINNOLAB Handheld Conductivity Meter Cond 351 i/ST.

TABLE 1
Effect of boric acid on pH of an electrolyte solution.

| | Boric acid | | | | | |
|---|---|---|---|---|---|---|
| % ZnCl₂ (M) | 0 | 0.1 | 0.2 | 0.3 | 0.4 | 0.5 |
| 5 | 3.18 | 3.38 | 3.44 | 3.57 | 3.64 | 3.73 |
| 6 | 2.50 | 2.64 | 2.79 | 2.90 | 3.04 | — |
| 7 | 1.87 | 2.05 | 2.21 | 2.36 | 2.49 | — |
| 8 | 1.20 | 1.25 | 1.55 | 1.66 | 1.80 | 1.95 |

TABLE 2
Effect of boric acid on conductivity
(mS/cm) of an electrolyte solution.

| | Boric acid | | | | | |
|---|---|---|---|---|---|---|
| % ZnCl₂ (M) | 0 | 0.1 | 0.2 | 0.3 | 0.4 | 0.5 |
| 5 | 75.8 | 77.8 | 80.0 | 82.1 | 83.6 | 86.3 |
| 6 | 60.4 | 63.8 | 66.8 | 68.8 | 73.7 | — |
| 7 | 47.1 | 50.8 | 54.6 | 59.6 | 62.6 | — |
| 8 | 33.0 | 35.8 | 39.4 | 42.7 | 82.1 | 86.3 |

It can be seen from the results that the conductivity and pH values increase when boric acid concentration increases.

### Example 1

10 parts of MnO₂, 1 part of graphite powder and 0.022 parts of boric acid in powdered form were mixed together and stirred for 10 to 20 minutes. For preparing a cathode paste material, 7 parts of an electrolyte solution consisting of 9 M ZnCl₂ and 3.5% PVA with a MW of 140,000 to 186,000 (Celvol 540, Celanese Chemicals) in an aqueous solution was then poured into the above powder mixture.

A thin battery comprising a cathode paste prepared above was manufactured as follows:

An anode was prepared by printing zinc ink on a separator paper. The amount of zinc ink was 12 mg/m².

A cathode collector was printed by using Creative Materials conductive carbon ink 116-19 ink on the polyethylene coated paper. After drying the cathode collector, the cathode paste was applied thereon to form a cathode.

The anode and cathode prepared above were then laminated together to form a thin battery assembly.

Measurements showed that the capacity of the thin battery was 1.6 mAh/cm².

### Example 2

10 parts of MnO₂ and 1 part of graphite powder were mixed together and stirred for 10 to 20 minutes. 6.3 parts of an aqueous electrolyte solution consisting of 9M ZnCl₂, 3.5% PVA with a MW of 140,000 to 186,000 (Celvol 540, Celanese Chemicals) and 0.22 parts of boric acid was then poured into the above powder mixture. Stirring was continued for one hour to form a cathode paste material. The total amount of boric acid amounts to 0.08% on weight basis of the cathode paste.

The viscosity of the electrolyte solution was about 2000 cps.

The cathode paste was applied on the cathode collector. A thin battery was assembled in the same manner as in Example 1.

The measurement showed that the capacity of the battery was 1.8 to 1.9 mAh/cm². The capacity was thus 10 to 20% higher than that of the battery in which boric acid is mixed as powder with the cathode active material in the manufacturing process of the cathode paste.

### Example 3

10 parts of MnO₂, 1 part of graphite powder and 0.08 parts of carbon nanotubes (from Timesnano) were mixed together and stirred for 10 to 20 minutes. 12 parts of an electrolyte solution consisting of 8M ZnCl₂, 1% CMC, 5% PVA with a MW of 140,000 to 186,000 (Celvol 540, Celanese Chemicals) and various amounts of boric acid in an aqueous solution was then poured into the above powder mixture. The amounts of boric acid are given in the Table 3 below.

Thin batteries comprising varied cathode paste materials of the invention were manufactured in the same manner as in Example 1. The capacity of the thin batteries and that of a similarly manufactured thin battery but without boric acid were measured during a period of one year at a room temperature.

TABLE 3
Performance of a thin battery

| Concentration of | | | | |
|---|---|---|---|---|
| boric acid (w-%) | % by weight | Initial | | Capacity |
| in the electrolyte | in the cathode | capacity | Capacity after | after one |
| solution | paste | mAh | 6 months | year |
| 0 | 0 | 61 | 44.2 | 28.4 |
| 0.111 | 0.058 | 62 | 51.1 | 46.1 |
| 0.154 | 0.080 | 61 | 58.5 | 56.1 |
| 0.250 | 0.13 | 62 | 47.4 | 32.6 |
| 0.311 | — | — | — | — |

The results show that the battery capacity is significantly improved during a long-term use of a battery by using boric acid therein compared to that of a battery without boric acid. This is specifically observable after one year life time. In the specific battery construction described above, i.e. in a ZnCl₂ concentration of 8 M, however, it was not possible to manufacture a thin battery with a boric acid concentration higher than 0.25%, such as 0.311% in the electrolyte solution, due to the printing problems caused by the cathode paste having too high viscosity.

After discharge of the above batteries, the batteries were detached in order to find out delamination characteristics thereof. It appeared that it was easier to detach the separate layers of a battery containing no boric acid than that which had a content of boric acid in the electrolyte layer. This indicates that including boric acid into a battery construction delamination of various layers of a battery can effectively be avoided.

It will be obvious to a person skilled in the art that, as the technology advances, the inventive concept can be implemented in various ways. The invention and its embodiments are not limited to the examples described above but may vary within the scope of the claims.

What is claimed is:

1. A cathode paste for a thin battery, comprising:
a cathode active material;
an electrolyte solution;
one or more binding agent; and
boric acid.

2. The cathode paste of claim 1, wherein the amount of boric acid ranges from 0.02 to 0.2%, preferably from 0.05 to 0.15%, more preferably 0.08% on weight basis of the cathode paste.

3. The cathode paste of claim 1, wherein the binding agent is selected from a group consisting of polyvinyl alcohol, carboxy methylcellulose and a mixture thereof.

4. The cathode paste of claim 1, wherein the cathode active material comprises MnO₂, and the electrolyte solution comprises ZnCl₂.

5. The cathode paste of claim 1, wherein the cathode paste comprises conductive material, such as carbon powder.

6. A method for preparing a cathode paste, comprising:
mixing a cathode active material, an optional conductive material and boric acid together to form a first, powered mixture;
mixing an electrolyte solution and binding agent(s) together to form a second mixture; and
adding the second mixture to the first mixture to form a cathode paste.

7. A method for preparing a cathode paste, comprising:
mixing a cathode active material with an optional conductive material to form a first, powdered mixture;
mixing an electrolyte solution, binding agent(s) and boric acid together to form a second mixture; and
adding the second mixture to the first mixture to form a cathode paste.

8. The method of claim 6, wherein the first mixture and the second mixture are mixed while stirring about for one hour.

9. A thin battery, comprising:
a cathode paste, the cathode paste comprising:
a cathode active material;
an electrolyte solution;
one or more binding agent; and
boric acid.

10. The thin battery of claim 9, comprising Zn ink as an anode material and one or more separator layers of paper.

11. A cathode, comprising:
a cathode paste, the cathode paste comprising:
a cathode active material;
an electrolyte solution;
one or more binding agent; and
boric acid.

12. A thin battery comprising:
an anode;
a cathode, comprising:
a cathode active material;
an electrolyte solution;
one or more binding agent; and
boric acid; and
a separator, such as paper, placed between said anode and said cathode.

13. The thin battery of claim 12, comprising sealing material around said anode, said cathode and said separator.

14. The method of claim 7, wherein the first mixture and the second mixture are mixed while stirring about for one hour.
